(19) United States
(12) Patent Application Publication
(10) Pub. No.: US 2016/0170613 A1
(43) Pub. Date: Jun. 16, 2016

(54) METHOD, SYSTEM, AND NON-TRANSITORY RECORDING MEDIUM FOR PROVIDING ADDITIONAL INFORMATION ASSOCIATED WITH INFORMATION LIST ON A DISPLAY

(71) Applicant: NAVER Corporation, Seongnam-si (KR)

(72) Inventors: Haengchul Shin, Seongnam-si (KR); Jin A. Jung, Seongnam-si (KR); Taihwa Hong, Seongnam-si (KR); Kyung Eun Lee, Seongnam-si (KR); Ryan Kim, Seongnam-si (KR)

(21) Appl. No.: 14/950,566

(22) Filed: Nov. 24, 2015

(30) Foreign Application Priority Data
Dec. 12, 2014 (KR) 10-2014-0179525

(51) Int. Cl. G06F 3/0484; G06F 3/0482

(52) U.S. Cl. CPC G06F 3/04842; G06F 3/0482

(57) ABSTRACT

Provided is a method, system, and non-transitory computer-readable medium for providing additional information using a list-type user interface. An information providing method includes displaying an information list, and displaying an information view window including additional information associated with a selected item in response to selecting the item from the information list. The displaying of the information view window includes closing an information view window of a previously selected item and displaying an information view window of a recently selected item in an interactive display form between consecutively selected items.

### CROSS-REFERENCE TO RELATED APPLICATION

This application claims priority from and the benefit of Korean Patent Application No. 10-2014-0179525, filed on Dec. 12, 2014, the disclosure of which is incorporated herein in its entirety by reference.

### BACKGROUND

1. Field

Example embodiments of the present invention relate to technology for providing a user interface in a list type.

2. Description of the Background

A mobile communication terminal released in the early stage generally has only a simple function of a mobile telephone, while a current mobile communication terminal has various multimedia functions, such as MP3 and the wireless Internet, beyond a simple calling function. Further, many additional functions, for example, mobile games and the wireless Internet, capable of using multimedia functions of the mobile communication terminal are in service.

Many mobile communication terminals perform a wireless Internet service using a wireless Internet browser, for example, a wireless application protocol (WAP) browser. Also, mobile communication terminals may search for a variety of information using a wireless Internet platform, for example, a general virtual machine (GVM), a binary runtime environment for wireless (BREW), and JAVA, without restrictions on time and occasion.

### SUMMARY

Some example embodiments of the present invention provide a method, a system, and/or a non-transitory computer-readable medium that provides additional information of an item selected from an information list.

Also, some example embodiments provide a method, a system, and/or a non-transitory computer-readable medium that selectively displays a meaning of a word on a wordbook list using a word memorizing and learning method.

Also, some example embodiments provide a method, a system, and/or a non-transitory computer-readable medium that automatically closes a meaning of a previously selected word and displays a meaning of a recently selected word in response to consecutively selecting words from a wordbook list.

According to at least one example embodiment, there is provided an information providing method implemented in a computer, the method including displaying an information list on the display of a user terminal, and displaying an information view window including additional information associated with a selected item in response to selecting the item from the information list, wherein the displaying of the information view window includes closing an information view window of a previously selected item and displaying an information view window of a recently selected item in an interactive display form between consecutively selected items.

The information list may be a list of words stored in a wordbook, and the displaying of the information view window may include displaying a meaning view window that includes a meaning of a word selected from the list of words, and closing a meaning view window of a previously selected word and displaying a meaning view window of a recently selected word in response to consecutively selecting words.

The displaying of the information list may include displaying basic information that includes spellings of each word in a basic state in which a meaning is hidden.

The displaying of the information view window may include simultaneously closing the information view window of the previously selected item and displaying the information view window of the recently selected item at a point in time at which an item is selected from the information list.

The displaying of the information view window may include displaying the information view window of the recently selected item at a point in time at which an item is selected from the information list, and displaying the information view window of the previously selected item together with the information view window of the recently selected item during a setting time and then closing the information view window of the previously selected item.

The setting time may be determined based on a selection time interval between the previously selected item and the recently selected item.

The information list may be configured by aligning a plurality of cards, and the displaying of the information view window may include displaying an information view window of an item selected from the information list in a pop-up form on a card of the selected item.

The displaying of the information view window may include dividing, into areas, a screen area on which the information list is displayed, displaying the information list on one of the divided areas, and displaying an information view window of the selected item on another area.

The information list may be configured by aligning a plurality of cards, and the displaying of the information view window may include displaying an information view window of the selected item through a screen transition in a card selected from the information list.

The displaying of the information view window may include maintaining an information view window of the selected item to be displayed until another item is selected from the information list.

The displaying of the information view window may include closing an information view window of the selected item in response to no selection of another item from the information list during a setting time after displaying the information view window of the selected item.

According to at least one example embodiment, there is provided a non-transitory computer-readable recording medium storing an instruction to control a computer system to provide information, wherein the instruction controls the computer system by a method including displaying an information list, and displaying an information view window including additional information associated with a selected item in response to selecting the item from the information list, and the displaying of the information view window includes closing an information view window of a previously selected item and displaying an information view window of a recently selected item in an interactive display form between consecutively selected items.

According to at least one example embodiment, there is provided an information providing system, including a memory to which at least one program is loaded, and at least one processor, wherein, according to a control of the program, the at least one processor is configured to process a process of displaying an information list, and a process of displaying an information view window including additional information associated with a selected item in response to selecting the item from the information list, and the process of displaying the information view window is a process of closing an information view window of a previously selected item and displaying an information view window of a recently selected item in an interactive display form between consecutively selected items.

The information list may be a list of words stored in a wordbook, and the process of displaying the information view window may be a process of displaying a meaning view window that includes a meaning of a word selected from the list of words, and closing a meaning view window of a previously selected word and displaying a meaning view window of a recently selected word in response to consecutively selecting words.

The process of displaying the information list may be a process of displaying basic information that includes spellings of each word in a basic state in which a meaning is hidden.

The process of displaying the information view window may be a process of simultaneously closing the information view window of the previously selected item and displaying the information view window of the recently selected item at a point in time at which an item is selected from the information list.

The process of displaying the information view window may be a process of displaying the information view window of the recently selected item at a point in time at which an item is selected from the information list, and displaying the information view window of the previously selected item together with the information view window of the recently selected item during a setting time and then closing the information view window of the previously selected item.

The setting time may be determined based on a selection time interval between the previously selected item and the recently selected item.

The information list may be configured by aligning a plurality of cards, and the process of displaying the information view window may be a process of displaying an information view window of an item selected from the information list in a pop-up form on a card of the selected item, or displaying the information view window of the selected item through a screen transition in the card selected from the information list.

The process of displaying the information view window may be a process of dividing, into areas, a screen area on which the information list is displayed, displaying the information list on one of the divided areas, and displaying an information view window of the selected item on another area, or closing the information view window of the selected item in response to no selection on another item from the information list during a setting time after displaying the information view window of the selected item.

It is to be understood that both the foregoing general description and the following detailed description are explanatory and are intended to provide further explanation of the example embodiments as claimed.

According to at least one example embodiment of the present invention, when providing additional information of an item selected from an information list, it is possible to provide an interface that enables a user to further easily verify information through interaction between consecutively selected items.

Also, according to at least one example embodiment, since it is possible to consecutively verify meanings of words from a list of words in a wordbook, it is possible to provide a learning method that enables a user to effectively memorize a word.

Also, according to at least one example embodiment, it is possible to improve a use convenience of a wordbook by automatically closing a meaning of a previously selected word and displaying a meaning of a recently selected word when consecutively selecting words from a list of words.

### BRIEF DESCRIPTION OF THE DRAWINGS

The foregoing and other features of the example embodiments of the present invention will be apparent from the more particular description of non-limiting embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a diagram illustrating a relationship between a user terminal and an information providing system according to one example embodiment.

FIG. 2 is a block diagram illustrating a configuration of an information providing system according to one example embodiment.

FIG. 3 is a flowchart illustrating an information providing method according to one example embodiment.

FIG. 4 illustrates an example of an initial execution screen of a wordbook according to one embodiment.

FIGS. 5 through 7 illustrate examples of a method of displaying a meaning view window according to example embodiments.

FIGS. 8 and 9 illustrate examples of a method of displaying a meaning view window in response to consecutively selecting words according to one embodiment.

FIG. 10 illustrates an example of a dictionary entry page of a selected word according to one embodiment.

FIG. 11 is a block diagram illustrating a configuration of a computer system according to one example embodiment.

### DETAILED DESCRIPTION

Example embodiments of the present invention will now be described more fully with reference to the accompanying drawings. Example embodiments, may, however, be embodied in many different forms and should not be construed as being limited to the embodiments set forth herein; rather, these example embodiments are provided so that this disclosure will be thorough and complete, and will fully convey the scope of the example embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein

Hereinafter, example embodiments of the present invention will be described with reference to the accompanying drawings.

At least one example embodiment relates to a user interface (UI) in a list type, and more particularly, to a method, system, and/or non-transitory computer-readable medium that provide additional information of an item selected from an information list.

Some example embodiments may be universally applied to any type of interface environments that may provide an information list and may provide additional information associated with each item included in the information list through a separate information view window.

Hereinafter, some example embodiments of a wordbook that provides a list of words and provides a meaning of a word selected from the list of words will be described as an example of a UI in a list type.

A wordbook service used herein is to provide a word and a meaning of the word for the purpose of memorizing and learning the word, and may indicate a service capable of storing words, idioms, and examples on the dictionary, and allowing a read, an edit, and a print thereof.

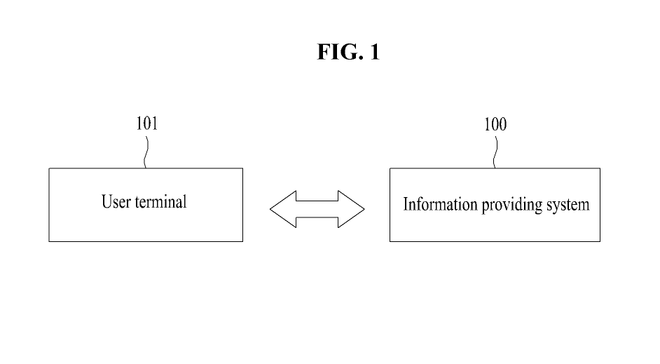

FIG. 1 is a diagram illustrating a relationship between a user terminal 101 and an information providing system 100 according to one example embodiment. In FIG. 1, an indicator with arrowheads may indicate that data may be transmitted and received between the information providing system 100 and the user terminal 101.

The user terminal 101 may refer to any type of terminal devices, for example, a mobile device such as a smartphone, a tablet, and a wearable computer, capable of connecting to a website/mobile site associated with the information providing system 100 or installing and executing a service exclusive application (hereinafter, a “wordbook App”). Here, the user terminal 101 may perform the overall service operations, such as service screen configuration, data input, data transmission and reception, data storage, or the like, under the control of the website/mobile site or the wordbook App.

The information providing system 100 serves as a service platform that provides a wordbook service to a client. Here, the information providing system 100 may be configured in an application form on the user terminal 101 and without being limited thereto, may be configured to be included in a service platform that provides a wordbook service in a client-server environment.

The wordbook App according to some example embodiments may include a basic function of providing a list of stored words and a function of providing the meaning of a word selected from the list of words. The wordbook App may be configured in an independently operating program form or an in-app form of a specific application, for example, a dictionary App and a translation App, to be operable on the specific application.

Hereinafter, although a service environment using the wordbook App is described, it is only an example. Thus, a wordbook service according to some example embodiments may be configured as a connection environment of a website/mobile site.

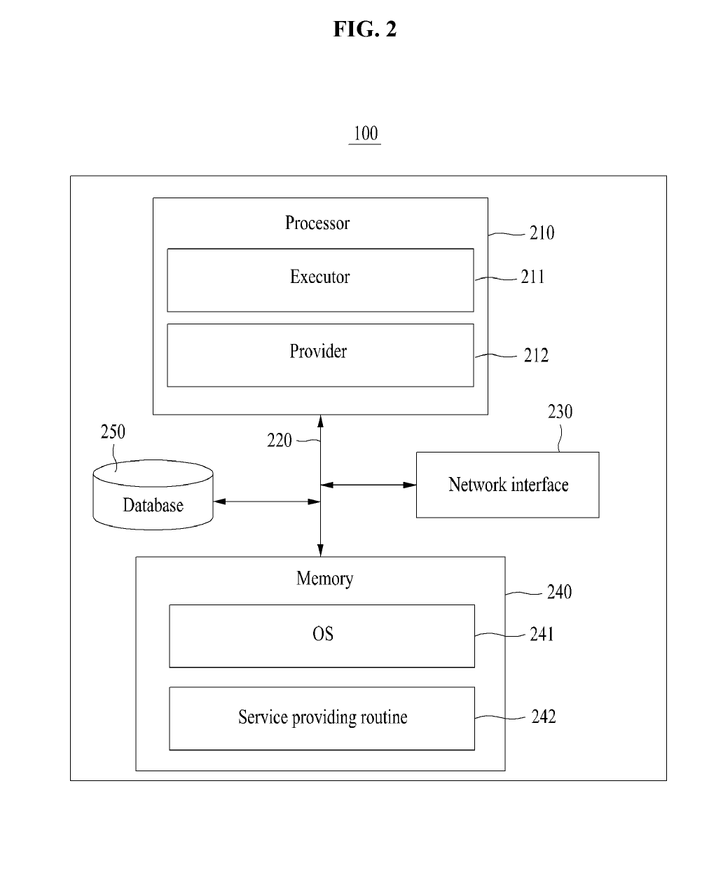

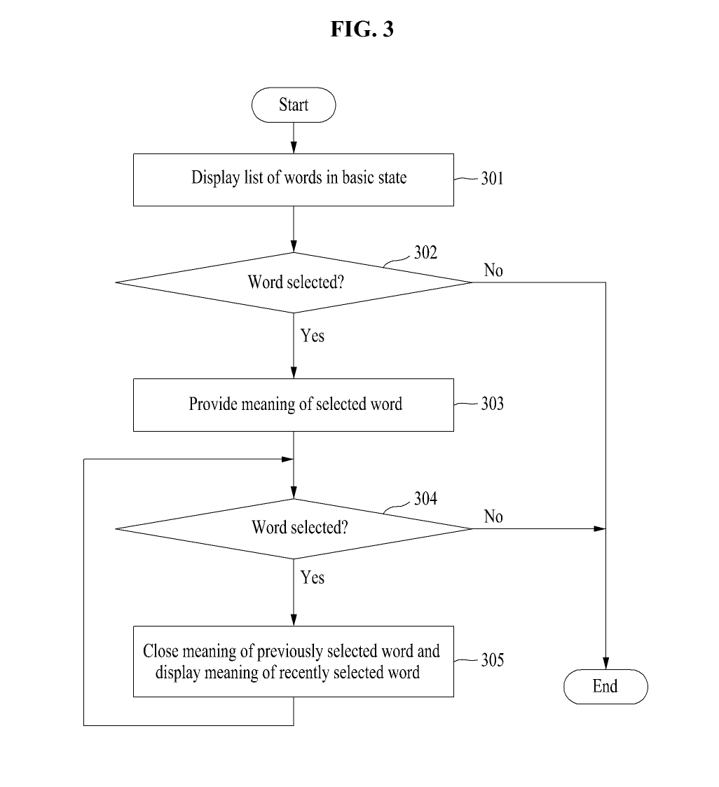

FIG. 2 is a block diagram illustrating a configuration of an information providing system 100 according to one example embodiment, and FIG. 3 is a flowchart illustrating an information providing method according to an example embodiment.

Referring to FIG. 2, the information providing system 100 includes a processor 210, a bus 220, a network interface 230, a memory 240, and a database 250. The memory 240 includes an operating system (OS) 241 and a service providing routine 242. The processor 210 includes an executor 211 and a provider 212. According to other example embodiments, the information providing system 100 may include more number of constituent elements than the number of constituent elements of FIG. 2.

The memory 240 may include a permanent mass storage device, such as a random access memory (RAM), a read only memory (ROM), and a disc drive, as a computer-readable storage medium. Also, program codes for the OS 241 and the service providing routine 242, and the like, may be stored in the memory 240. Such software constituent elements may be loaded from another computer-readable storage medium separate from the memory 240 using a drive mechanism (not shown). Other computer-readable storage medium may include, for example, a floppy drive, a disc, a tape, a DVD/CD-ROM drive, and a memory card. Software constituent elements may be loaded to the memory 240 through the network interface 230 instead of using the computer-readable storage medium.

The bus 220 enables communication and data transmission between the constituent elements of the information providing system 100. The bus 220 may be configured using a high-speed serial bus, a parallel bus, a storage area network (SAN), and/or another appropriate communication technology.

The network interface 230 may be a computer hardware constituent element for connecting the information providing system 100 to the computer network. The network interface 230 may connect the information providing system 100 to the computer network through a wireless or wired connection.

The database 250 is configured by a wordbook App and serves to store and maintain basic dictionary information of a word defined or selected on the dictionary. The database 250 may be used to provide a wordbook function in an offline local environment. For example, basic dictionary information may include spellings, phonetic symbols, sound data of a pronunciation, and at least a portion of meanings for each word. Here, at least a portion of meanings is limited to a primary meaning including 20 or less letters among a plurality of meanings of a word defined on the dictionary. The database 250 may be included in a dictionary database that is applied to a dictionary function and may be configured using the dictionary database. Although FIG. 2 illustrates that the database 250 is included in the information providing system 100, the database 250 may be provided as an external database constructed in a separate system. Here, the external database may inclusively indicate a database included in another function, for example, a dictionary function and a voice recognition function, capable of interacting with the information providing system 100 in a local environment.

The processor 210 is configured to process computer-readable instructions of a computer program by performing basic calculations, logic, and input/output operations of the information providing system 100. The computer-readable instructions may be provided from the memory 240 or the network interface 230 to the processor 210 through the bus 220. The processor 210 is configured to execute program codes for the executor 211 and the provider 212, which are additional functions or processes performed by the processor 210. The program codes may be stored in a storage device such as the memory 240.

When executed by the processor 210, the computer-readable instructions associated with the executor 211 and the provider 214 specially configures the processor to perform operations 301 through 305 of FIG. 3.

Referring to FIG. 3, in operation 301, the executor 211 may execute a wordbook by displaying a list of stored words on the display screen of the user terminal 101. Here, the executor 211 may list and display all of or a portion of words stored in the wordbook. When a portion of the stored words is listed, the executor 211 may extract a desired or alternatively predetermined number of words randomly or based on a predetermined criterion, for example, a time at which a word is stored and whether a word is to be memorized, and may generate a card of the extracted words as a list. A list of words may be configured as a plurality of word cards and each word card may include minimum information that includes spellings. In particular, the meaning of a word is not included in the minimum information. Only basic information, for example, spellings of the word, phonetic symbols of the word, and a UI for outputting a pronunciation of the word as sound, may be included in the minimum information. That is, the executor 211 may display a list of words including a plurality of word cards. In this instance, the executor 211 may display the list of words in a basic state in which only basic information of each word is displayed and the meaning thereof is not displayed.

In operations 302 and 303, when a word is initially selected from the list of words, the provider 212 provides the meaning of the selected word through a separate window (hereinafter, a meaning view window). The selection of the word may be recognized using a variety of input devices, for example, a touch sensor and a proximity sensor. For example, in response to selecting a word, the provider 212 may overlap and thereby display a meaning view window on a card of the selected word in a pop-up form. Here, the meaning view window may be configured in a variety of designs without occluding information displayed on other cards, excluding the selected word. Further, when displaying the meaning view window in an overlapping manner, the provider 212 may apply a transparency to the meaning view window so that a background appears opaque. As another example, in response to selecting a word, the provider 212 may display the meaning of the selected word by providing a meaning view window on one area divided through a screen division. For example, the provider 212 may divide an area on which a list of words is displayed prior to selecting a word into two areas at a point in time at which the word is selected, and may simultaneously display the list of words and a meaning view window on the two areas, respectively. Here, the screen division may variously configure a screen, for example, a vertical screen, a horizontal screen, and a diagonal screen, and may determine a division ratio based on an amount of information to be displayed. When displaying a meaning view window using a screen division method, the provider 212 may display a word selected from a list of words to be distinguished from other words using, for example, a highlight, bold, a word color, and shadowing. As another example, in response to selecting a word, the provider 212 may display the meaning of the selected word by switching from a card of the selected word to a meaning view window through a screen transition. In this example, the screen transition may indicate any type of animation effects that may be applicable when changing a screen from a card of the selected word to a meaning view window to provide the meaning view window of the selected word.

As described above, in response to selecting a specific word from a list of words in a basic state, the provider 212 may provide a meaning view window using a variety of methods, and may display the meaning of the selected word through the meaning view window. Here, the provider 212 may maintain a meaning view window of a previously selected word to be displayed until another word is newly selected from the list of words. When a user inputs a cancel button of the meaning view window or selects a position on the meaning view window, the provider 212 may close the meaning view window, may return to a basic state, and may display a list of words. As another example, when another word is not newly selected during a setting time after displaying a meaning view window of a selected word, the provider 212 may automatically close the meaning view window at a point in time at which the setting time is elapsed and may return to the basic state. The setting time may be set by the user as an environment setting of a wordbook.

In operations 304 and 305, when another word is newly selected while displaying the meaning view window, the provider 212 displays the meaning of the word by automatically closing a meaning view window of the previously selected word and by providing a meaning view window of the recently selected word. That is, when words are consecutively selected from a list of words, the previously displayed meaning view window is automatically closed and a meaning view window of a recently selected word is opened in response to selecting the new word, although the user does not close the meaning view window of the previously displayed word himself. For example, at a point in time at which another word is newly selected while displaying a meaning view window, the provider 212 may simultaneously close the meaning view window of the previously selected word and provide a meaning view window of the recently selected word. As another example, when consecutively selecting words, the provider 212 may apply an overlapping time in which a meaning view window of a previously selected word and a meaning view window of a recently selected word are displayed together and thus, may temporarily maintain and then close the meaning view window of the previously selected word even after providing the meaning view window of the recently selected word. Here, the overlapping time in which the meaning view window of the previously selected word is maintained after selecting the new word may be determined based on a selection time interval between the consecutively selected words. For example, according to an increase in the word selection time interval, the overlapping time may be set to decrease. On the contrary, according to a decrease in the word selection time interval, the overlapping time may be set to increase.

According one example embodiment, the provider 212 may provide a wordbook service in an offline local environment based on basic dictionary information stored in the database 250. Here, in response to selecting a word or a meaning displayed on the meaning view window or selecting a position on the meaning view window, the provider 212 may move to an entry page for providing the entire dictionary information present in a dictionary database. The entire dictionary information may include the entire meanings for each word class, for example, a noun, a verb, an adjective, and an adverb, inflectional words, related words/idioms, synonyms/anonyms, related examples, translations of examples, and comments on the translations. When the dictionary database for providing the entry page is present as an external database on the Internet, the provider 212 may verify whether a user terminal 101 is connectable to a network. Here, when the user terminal 101 is connectable to the network, that is, in a network connectable state, the provider 212 may provide an entry page for the selected word. On the contrary, when the user terminal 101 is not connectable to the network and in this state, a word or a meaning displayed on the meaning view window is selected or a position on the meaning view window is selected, or when a page back (alt+left arrow indicator) on the entry page is executed, the provider 212 may return to a basic state of the wordbook and may display a list of words.

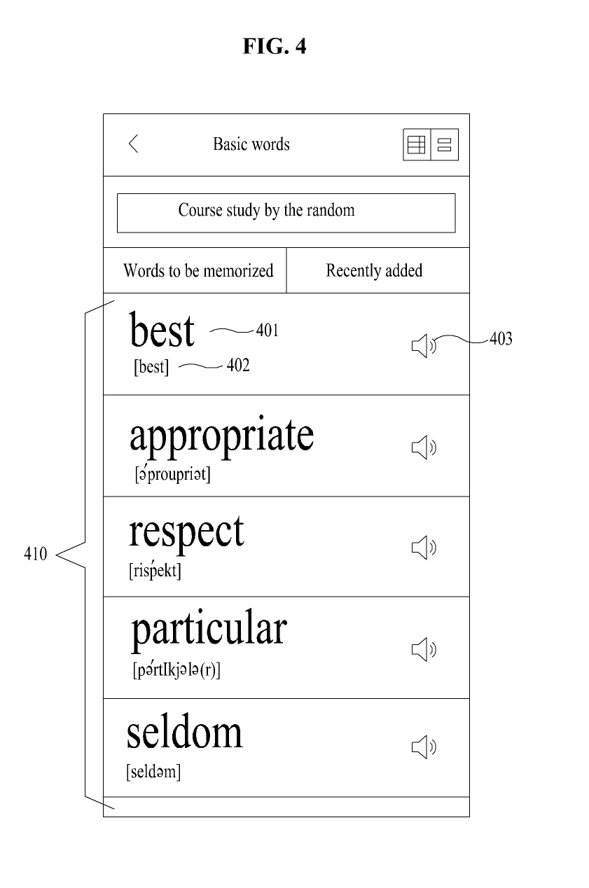

FIG. 4 illustrates an example of an initial execution screen of a wordbook according to one embodiment.

Referring to FIG. 4, once the wordbook is executed, a list of words 410 stored in the wordbook may be displayed on the display screen of the user terminal 101 in a basic state in which the meaning of a word is not displayed and only minimum information is displayed. Here, individual word cards may be sorted as a list and be displayed on the list of words 410. Spellings 401 and phonetic symbols 402 of a word, and a pronunciation sound button 403 may be displayed on each word card. Accordingly, the user may verify spellings, phonetic symbols, and pronunciation of individual words using the initial execution screen of the wordbook provided in the basic state. In particular, the user may memorize and learn words while recalling meanings of individual words that are not displayed in the basic state.

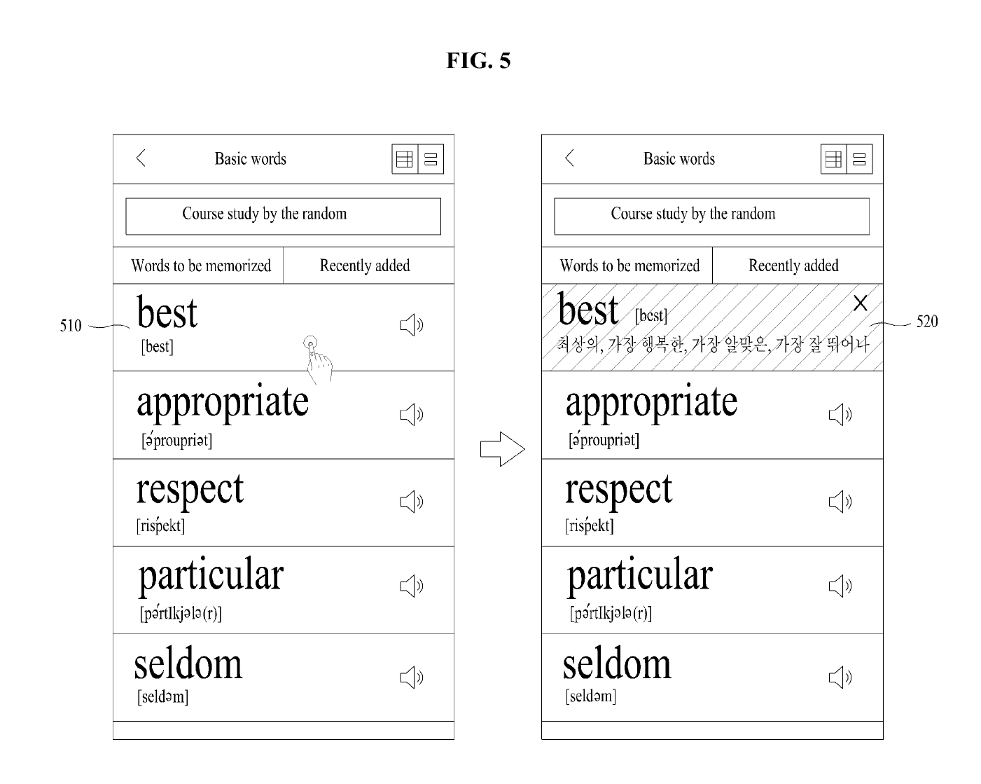

FIGS. 5 through 7 illustrate examples of a method of displaying a meaning view window according to some example embodiments.

Referring to FIG. 5, as an example of a display method, in response to selecting a specific word card 510 from a wordbook list, a meaning view window 520 may be popped up and may be displayed on the selected word card 510 in an overlapping form.

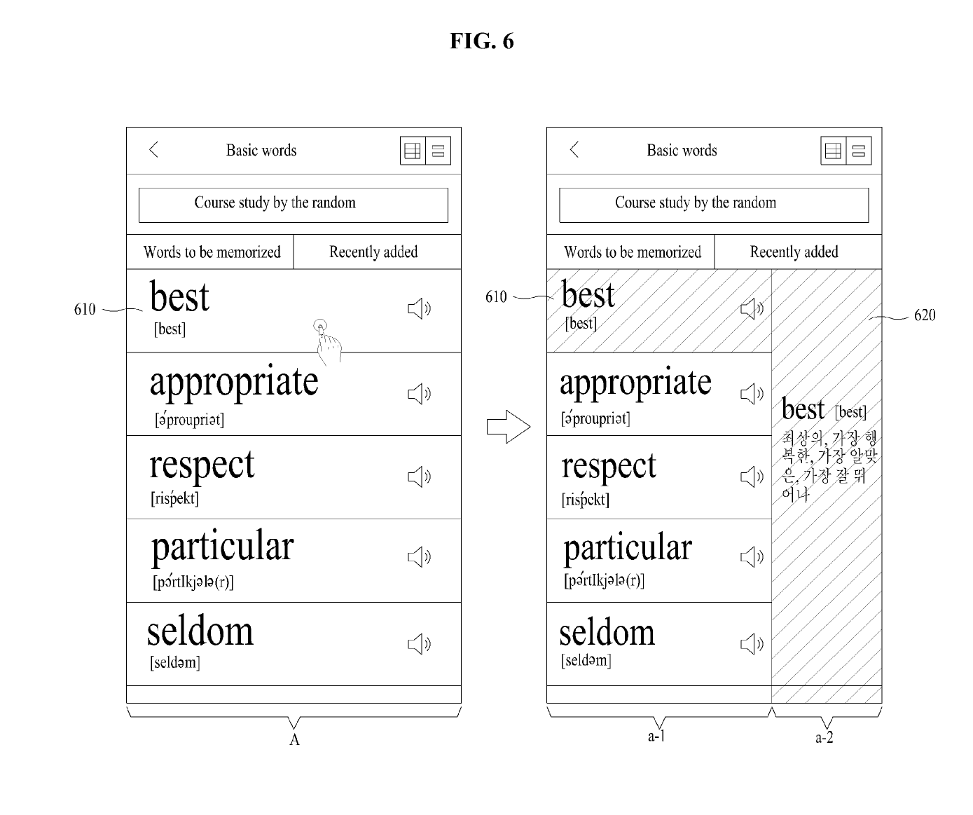

Referring to FIG. 6, as another example of the display method, in response to selecting a specific word card 610 from a wordbook list, a previous area A on which a list of words is displayed may be divided into two areas a-1 and a-2. The list of words may be displayed on one area a-1 and a meaning view window 620 may be displayed on the other area a-2. In addition, while displaying the meaning view window 620, the selected word card 610 may be shadowing processed and displayed to be distinguished from other words on the list of words.

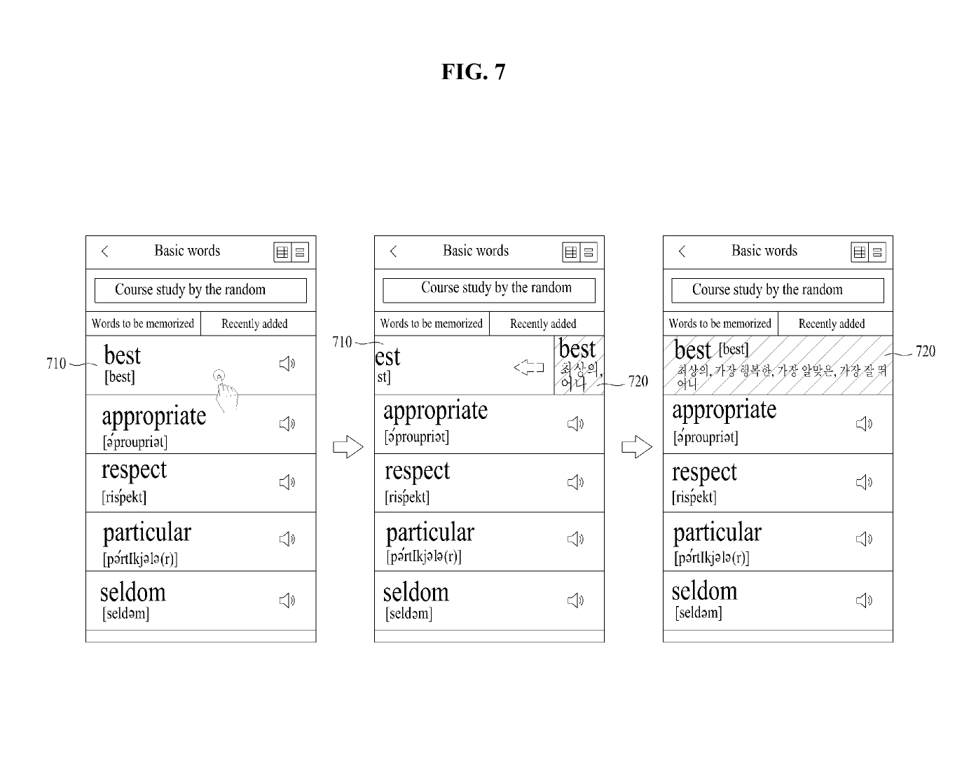

Referring to FIG. 7, as still another example of the display method, in response to selecting a specific word card 710 from a wordbook list, a meaning view window 720 may be displayed through a screen transition from the selected word card 710. For example, the meaning view window 720 may be displayed by applying an animation effect that the selected word card 710 disappears from the left along an arrow indicator indicated with dotted lines and the meaning view window 720 appears from the right.

Accordingly, a meaning of a word is invisible on an initial execution screen of a wordbook and appears through a meaning view window in response to selecting the word. Accordingly, the user may verify the meaning of the word through an individual word selection.

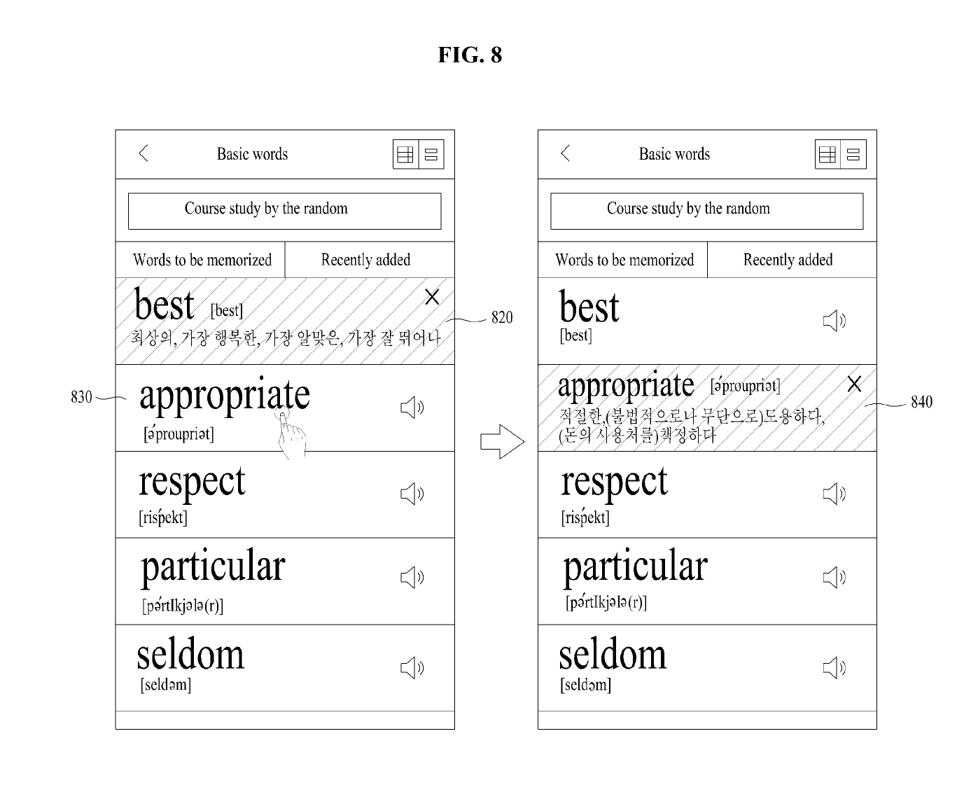

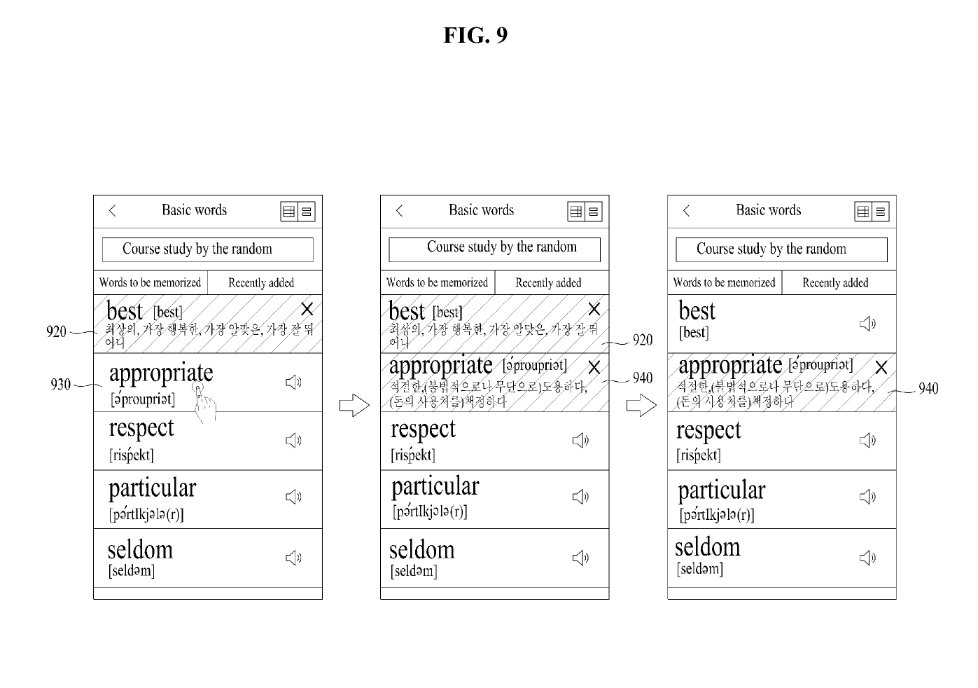

FIGS. 8 and 9 illustrate examples of a method of displaying a meaning view window in response to consecutively selecting words according to some embodiments.

Referring to FIG. 8, when another word card 830 is consecutively selected in a state in which a meaning view window 820 of a previously selected word is displayed, the meaning view window 820 of the previously selected word is automatically closed and a meaning view window 840 of a recently selected word is open, that is, displayed.

Accordingly, when the user selects another word without a need to close the meaning view window 820 of the previously selected word, the user may consecutively verify and memorize meanings of words since the meaning view window 820 is automatically closed and the meaning view window 840 of the recently selected word is displayed.

As another example, referring to FIG. 9, when another word card 930 is consecutively selected in a state in which a meaning view window 920 of a previously selected word is displayed, the meaning view window 920 of the previously selected word and a meaning view window 940 of a recently selected word are displayed together temporarily and the meaning view window 920 of the previously selected word is closed after a predetermined period of time has elapsed. That is, by applying an overlapping time in which the meaning view window 920 of the previously selected word is maintained after selecting a new word, the meaning view window 920 of the previously selected word may be maintained to be displayed temporarily even after providing the meaning view window 940 of the recently selected word and then be closed.

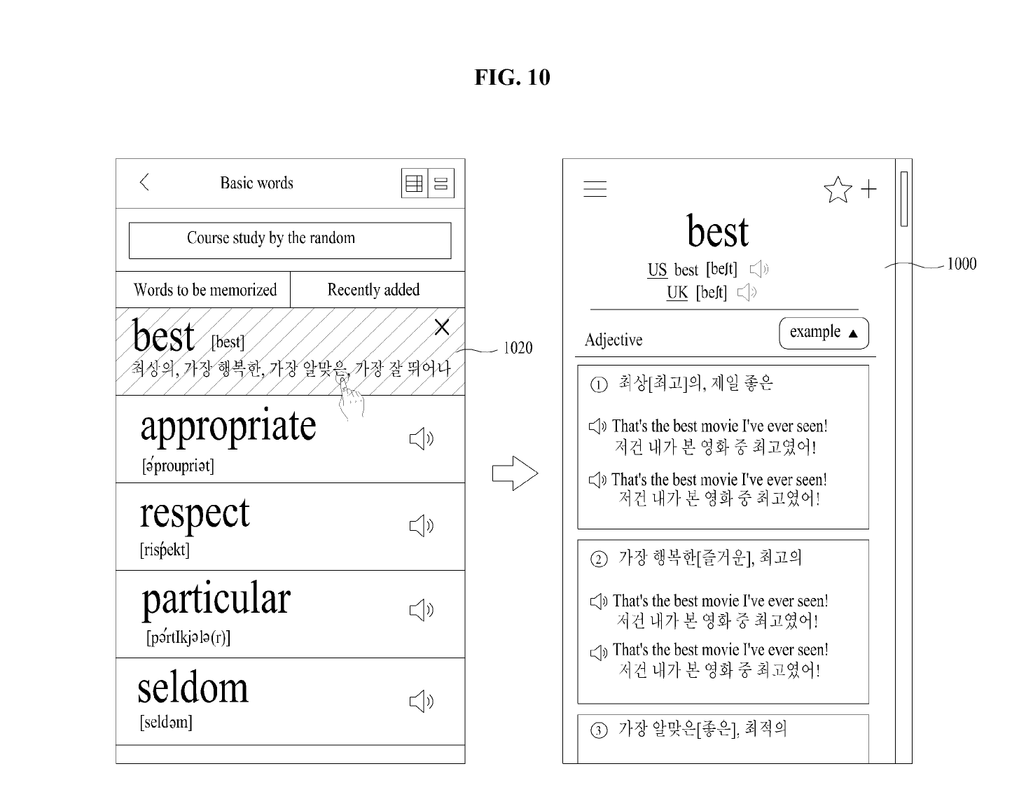

FIG. 10 illustrates an example of a dictionary entry page of a selected word according to an example embodiment.

Referring to FIG. 10, in response to selecting a position on a meaning view window 1020 of a selected word in a state in which the meaning view window 1020 of the selected word is displayed, a user may move to an entry page 1000 for providing the entire dictionary information of the selected word.

Accordingly, the user may simply verify a meaning of the selected word through the meaning view window 1020 and touch the meaning view window 1020 if the user needs to verify additional information. In response thereto, the entry page 1000 is provided. The user may verify the entire information on the dictionary, for example, meanings for each word class and related examples, from the entry page 1000.

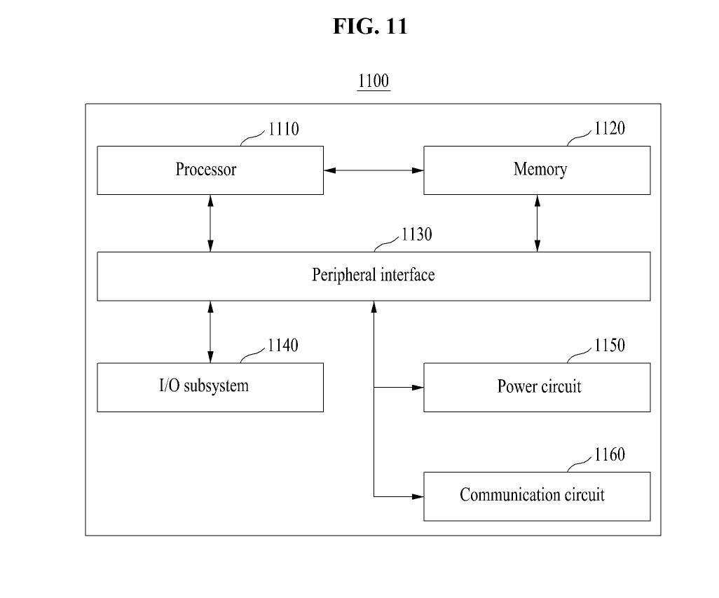

FIG. 11 is a block diagram illustrating an example of a configuration of a computer system 1100 according to one example embodiment. Referring to FIG. 11, the computer system 1100 may include at least one processor 1110, a memory 1120, a peripheral interface 1130, an input/output (I/O) subsystem 1140, a power circuit 1150, and a communication circuit 1160. Here, the computer system 1100 corresponds to the user terminal 101.

The memory 1120 may include, for example, a high-speed random access memory (HSRAM), a magnetic disk, a static random access memory (SRAM), a dynamic RAM (DRAM), read only memory (ROM), a flash memory, and a non-volatile memory. The memory 1120 may include a software module, an instruction set, or a variety of data required for an operation of the computer system 1100. Here, an access from another component such as the processor 1110 and the peripheral interface 1130 to the memory 1120 may be controlled by the processor 1110.

The peripheral interface 1130 may couple an input device and/or output device of the computer system 1100 with the processor 1110 and the memory 1120. The processor 1110 may perform a variety of functions for the computer system 1100 and process data by executing the software module or the instruction set stored in the memory 1120.

The I/O subsystem 1140 may couple various I/O peripheral devices with the peripheral interface 1130. For example, the I/O subsystem 1140 may include a controller for coupling the peripheral interface 1130 and a peripheral device such as a monitor, a keyboard, a mouse, a printer, and a touch screen or a sensor depending on a necessity. The I/O peripheral devices may be coupled with the peripheral interface 1130 without using the I/O subsystem 1140.

The power circuit 1150 may supply a power to all of or a portion of components of a terminal. For example, the power circuit 1150 may include a power management system, at least one power source such as a battery and alternating circuit (AC), a charge system, a power failure detection circuit, a power converter or inverter, a power status indicator, or other components for creating, managing and distributing power.

The communication circuit 1160 enables communication with another computer system using at least one external port. Alternatively, as described above, the communication circuit 1160 may enable communication with another computer system by including a radio frequency (RF) circuit and thereby transmitting and receiving an RF signal known as an electromagnetic signal.

The example embodiment of FIG. 11 is only an example of the computer system 1100. The computer system 1100 may have a configuration or an arrangement for omitting a portion of the components illustrated in FIG. 11, further including components not illustrated in FIG. 11, or coupling two or more components. For example, a computer system for a communication terminal of a mobile environment may further include a touch screen, a sensor, and the like, in addition to the components of FIG. 11. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 1160. Components includable in the computer system 1100 may be configured as hardware that includes an integrated circuit specified for at least one signal processing or application, software, or a combination of hardware and software.

The information providing method may include a reduced number of operations or additional operations based on descriptions made above with reference to FIGS. 1 through 10. Also, two or more operations may be combined and orders or positions of operations may be modified.

The methods according to the example embodiments may be configured in a program instruction form executable through various computer systems and thereby recorded in non-transitory computer-readable media.

A program according to the example embodiments may be configured as a PC-based program or an application exclusive for a mobile terminal. Also, the methods according to the example embodiments may be performed by controlling, by the wordbook App, a user terminal. Such an application may be installed in the user terminal through a file provided from a file distribution system. As an example, the file distribution system may include a file transmitter (not shown) to transmit the file in response to a request from the user terminal.

As described above, according to some example embodiments, when providing additional information of an item selected from an information list, it is possible to provide an interface that enables a user to further easily verify information through interaction between consecutively selected items. Also, according to some example embodiments, since it is possible to consecutively verify meanings of words from a list of words in a wordbook, it is possible to provide a learning method that enables a user to effectively memorize a word. Also, according to some example embodiments, it is possible to improve a use convenience of a wordbook by automatically closing a meaning of a previously selected word and displaying a meaning of a recently selected word when consecutively selecting words from a list of words.

The apparatuses described herein may be implemented using hardware components, software components, or a combination thereof. For example, a processing device such as the processor 210 may be implemented using one or more computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing greater level code that may be executed by the computer using an interpreter. The described hardware devices may be to act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. An information providing method implemented in a computer, the method comprising:
displaying an information list on a display of a user terminal; and
displaying, on the display of the user terminal, an information view window comprising additional information associated with a selected item in response to selecting the item from the information list,
wherein the displaying of the information view window comprises closing an information view window of a previously selected item and displaying an information view window of a recently selected item in an interactive display form between consecutively selected items.

2. The method of claim 1, wherein the information list is a list of words stored in a wordbook, and
the displaying of the information view window comprises displaying a meaning view window that comprises a meaning of a word selected from the list of words, and closing a meaning view window of a previously selected word and displaying a meaning view window of a recently selected word in response to consecutively selecting words.

3. The method of claim 2, wherein the displaying of the information list comprises displaying basic information that comprises spellings of each word in a basic state in which a meaning of each word is hidden.

4. The method of claim 1, wherein the displaying of the information view window comprises simultaneously closing the information view window of the previously selected item and displaying the information view window of the recently selected item at a point in time at which an item is selected from the information list.

5. The method of claim 1, wherein the displaying of the information view window comprises displaying the information view window of the recently selected item at a point in time at which an item is selected from the information list, and displaying the information view window of the previously selected item together with the information view window of the recently selected item during a setting time and then closing the information view window of the previously selected item.

6. The method of claim 5, wherein the setting time is determined based on a selection time interval between the previously selected item and the recently selected item.

7. The method of claim 1, wherein the information list is configured by aligning a plurality of cards, and
the displaying of the information view window comprises displaying an information view window of the selected item from the information list in a pop-up form on a card of the selected item.

8. The method of claim 1, wherein the displaying of the information view window comprises dividing the display of the user terminal into a plurality of areas and displaying the information list on one of the divided areas, and displaying an information view window of the selected item on another of the divided areas.

9. The method of claim 1, wherein the information list is configured by aligning a plurality of cards, and
the displaying of the information view window comprises displaying the information view window of the selected item through a screen transition in a card selected from the information list.

10. The method of claim 1, wherein the displaying of the information view window comprises maintaining the information view window of the selected item until another item is selected from the information list.

11. The method of claim 1, wherein the displaying of the information view window comprises closing the information view window of the selected item in response to no selection of another item from the information list during a setting time after displaying the information view window of the selected item.

12. A non-transitory computer-readable recording medium storing instructions to control a computer system to provide information, wherein the instruction controls the computer system to perform the steps comprising:
displaying an information list on a display of a user terminal; and
displaying, on the display of a user terminal, an information view window comprising additional information associated with a selected item in response to selecting the item from the information list, and
the displaying of the information view window comprises closing an information view window of a previously selected item and displaying an information view window of a recently selected item in an interactive display form between consecutively selected items.

13. An information providing system, comprising:
a memory in which at least one program is loaded; and
at least one processor,
wherein, according to a control of the program, the at least one processor is configured to perform:
a process of displaying an information list on a display of a user terminal; and
a process of displaying, on the display of the user terminal, an information view window comprising additional information associated with a selected item in response to selecting the item from the information list, and
the process of displaying the information view window is a process of closing an information view window of a previously selected item and displaying an information view window of a recently selected item in an interactive display form between consecutively selected items.

14. The information providing system of claim 13, wherein the information list is a list of words stored in a wordbook, and
the process of displaying the information view window is a process of displaying a meaning view window that comprises a meaning of a word selected from the list of words, and closing a meaning view window of a previously selected word and displaying a meaning view window of a recently selected word in response to consecutively selecting words.

15. The information providing system of claim 14, wherein the process of displaying the information list is a process of displaying basic information that comprises spellings of each word in a basic state in which a meaning of each word is hidden.

16. The information providing system of claim 13, wherein the process of displaying the information view window is a process of simultaneously closing the information view window of the previously selected item and displaying the information view window of the recently selected item at a point in time at which an item is selected from the information list.

17. The information providing system of claim 13, wherein the process of displaying the information view window is a process of displaying the information view window of the recently selected item at a point in time at which an item is selected from the information list, and displaying the information view window of the previously selected item together with the information view window of the recently selected item during a setting time and then closing the information view window of the previously selected item.

18. The information providing system of claim 17, wherein the setting time is determined based on a selection time interval between the previously selected item and the recently selected item.

19. The information providing system of claim 13, wherein the information list is configured by aligning a plurality of cards, and
the process of displaying the information view window is a process of displaying an information view window of the selected item from the information list in a pop-up form on a card of the selected item, or displaying the information view window of the selected item through a screen transition in the card selected from the information list.

20. The information providing system of claim 13, wherein the process of displaying the information view window is a process of dividing the display of the user terminal into a plurality of areas and displaying the information list on one of the divided areas, and displaying an information view window of the selected item on another of the divided areas, or closing the information view window of the selected item in response to no selection on another item from the information list during a setting time after displaying the information view window of the selected item.
